(19) United States
(12) Patent Application Publication
(10) Pub. No.: US 2003/0145947 A1
(43) Pub. Date: Aug. 7, 2003

(54) Semiconductor device, method of manufacturing the same, manufacturing apparatus for the same, and electronic instrument

(75) Inventors: Michiyoshi Takano, Chino-shi (JP); Hideki Yuzawa, Iida-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/340,544

(22) Filed: Jan. 10, 2003

(30) Foreign Application Priority Data
Jan. 16, 2002 (JP) 2002-007713

(51) Int. Cl. B32B 31/00

(52) U.S. Cl. 156/292

(57) ABSTRACT

A method of manufacturing a semiconductor device including: placing a substrate on a bonding stage; and bonding a semiconductor chip to the substrate. At least a section of the bonding stage which is in contact with the substrate is formed of a material having a thermal conductivity of 15 to 30 W·m⁻¹·K⁻¹.

Japanese Patent Application No. 2002-7713, filed on Jan. 16, 2002, is hereby incorporated by reference in its entirety.

### BACKGROUND OF THE INVENTION

The present invention relates to a semiconductor device, a method of manufacturing the semiconductor device, a manufacturing apparatus for the semiconductor device, and an electronic instrument.

In the case of bonding electrodes to leads in face down bonding by placing a substrate on which the leads are formed on a bonding stage, placing a semiconductor chip having the electrodes on the substrate, and applying pressure and heat to the semiconductor chip by using a bonding tool, the bonding stage is heated by the heat from the bonding tool. If the bonding stage is formed of a material having a low thermal conductivity such as quartz glass, heat is transferred from the bonding stage to the substrate on which the leads are formed, whereby the substrate may be influenced by the heat. If the substrate is expanded by the heat, the pitch of the leads is increased and becomes unequal to the pitch of the bumps. If the substrate is cooled and shrinks, the pitch of the leads is reduced, whereby the bumps bonded to the leads are tilted. If the substrate is warped due to heat, the leads may come in contact with an IC. If the substrate softens due to heat, bonded part of the leads and the bumps may sink into the substrate. In this case, since the gap between the substrate and the IC is reduced, it is difficult to fill the gap with an underfill material, whereby voids easily occur. In addition, a eutectic alloy formed in the bonded part of the leads and the bumps sometimes overflows from the substrate to be spread in the direction of the pitch of the bumps, whereby the adjacent bumps may be short-circuited.

### BRIEF SUMMARY OF THE INVENTION

A method of manufacturing a semiconductor device according to a first aspect of the present invention comprises:

placing a substrate on a bonding stage; and

bonding a semiconductor chip to the substrate,

wherein at least a section of the bonding stage which is in contact with the substrate is formed of a material having a thermal conductivity of 15 to 30 W·m⁻¹·K⁻¹.

A semiconductor device according to a second aspect of present invention is manufactured by the above method.

An electronic instrument according to a third aspect of the present invention comprises the above semiconductor device.

A manufacturing apparatus for a semiconductor device according to a fourth aspect of the present invention comprises:

a bonding stage on which a substrate is placed; and

a bonding tool for bonding a semiconductor chip to the substrate,

wherein at least a section of the bonding stage which is in contact with the substrate is formed of a material having a thermal conductivity of 15 to 30 W·m⁻¹·K⁻¹.

### BRIEF DESCRIPTION OF THE SEVERAL VIEWS OF THE DRAWING

FIG. 1 is a view showing a semiconductor device according to one embodiment of the present invention.

FIG. 2 is a view illustrating a method of manufacturing a semiconductor device according to one embodiment of the present invention.

FIG. 3 is a partially enlarged view of FIG. 2.

FIG. 4 is a view illustrating a method of manufacturing a semiconductor device according to one embodiment of the present invention.

FIG. 5 is a view showing an electronic instrument according to one embodiment of the present invention.

FIG. 6 is a view showing another electronic instrument according to one embodiment of the present invention.

FIG. 7 is a view showing still another electronic instrument according to one embodiment of the present invention.

### DETAILED DESCRIPTION OF THE EMBODIMENT

The present invention may reduce the heat influence on a substrate.

(1) A method of manufacturing a semiconductor device according to one embodiment of the present invention comprises:

placing a substrate on a bonding stage; and

bonding a semiconductor chip to the substrate,

wherein at least a section of the bonding stage which is in contact with the substrate is formed of a material having a thermal conductivity of 15 to 30 W·m⁻¹·K⁻¹.

According to this embodiment of the present invention, the material which forms at least a section of the bonding stage which is in contact with the substrate has a thermal conductivity of 15 W·m⁻¹·K⁻¹ or more, so that heat of the substrate can be released. Therefore, the heat influence on the substrate can be reduced. Moreover, since the material has a thermal conductivity of 30 W·m⁻¹·K⁻¹ or less, the semiconductor chip can be bonded to the substrate without excessively releasing the heat of the substrate.

(2) In this method of manufacturing a semiconductor device, the material for the bonding stage may be stainless steel.

(3) A semiconductor device according to one embodiment of the present invention is manufactured by the above method.

(4) An electronic instrument according to one embodiment of the present invention comprises the above semiconductor device.

(5) A manufacturing apparatus for a semiconductor device according to one embodiment of the present invention comprises:

a bonding stage on which a substrate is placed; and

a bonding tool for bonding a semiconductor chip to the substrate,

wherein at least a section of the bonding stage which is in contact with the substrate is formed of a material having a thermal conductivity of 15 to 30 W·m⁻¹·K⁻¹.

According to this embodiment of the present invention, the material which forms at least a section of the bonding stage which is in contact with the substrate has a thermal conductivity of 15 W·m⁻¹·K⁻¹ or more, so that heat of the substrate can be released. Therefore, the heat influence on the substrate can be reduced. Moreover, since the material has a thermal conductivity of 30 W·m⁻¹·K⁻¹ or less, bonding of the semiconductor chip is not hindered.

(6) In this manufacturing apparatus for a semiconductor device, the material for the bonding stage may be stainless steel.

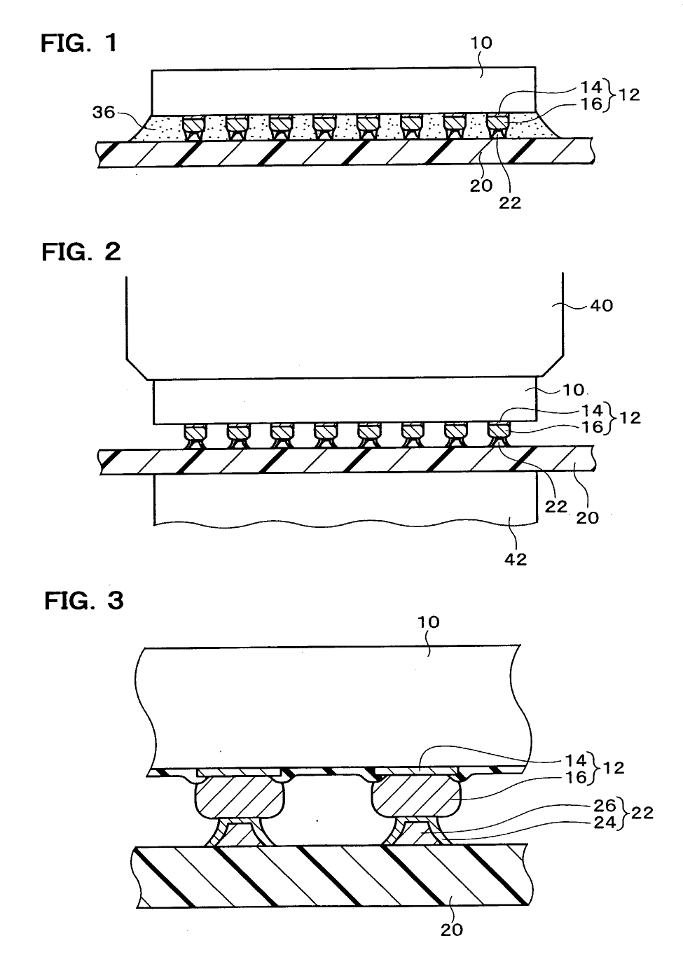

One embodiment of the present invention will be described below with reference to the drawings. FIG. 1 is a view showing a semiconductor device according to one embodiment of the present invention. The semiconductor device includes a semiconductor chip 10 and a substrate 20. The semiconductor chip 10 is an integrated circuit chip. The semiconductor chip 10 has a plurality of electrodes 12. Each of the electrodes 12 may be formed by a pad 14 and a bump 16, or only by the pad 14. The pad 14 may be formed of aluminum, and the bump 16 may be formed of gold, for example. The bump 16 may be formed by plating, or formed as a ball for wire bonding.

The substrate 20 may be a flexible substrate, a film substrate, or a rigid substrate. The substrate 20 may have a configuration in which a plurality of leads 22 are formed on a base substrate of a polyimide resin, for example. In this case, an interconnecting pattern is formed by the leads 22. As shown in FIG. 3, the leads 22 before being bonded to the electrodes 12 (bumps 16) of the semiconductor chip 10 may have a surface layer 24 and an inner layer 26. In this case, the surface layer 24 is formed of a soldering or brazing material such as tin (Sn) or solder, and the inner layer 26 is formed of copper (Cu), for example. At least one of the surface layer 24 and the inner layer 26 may be formed by a plurality of layers.

The semiconductor chip 10 is bonded face down to the substrate 20. Specifically, the semiconductor chip 10 is bonded to the substrate 20 in a state in which the side of the semiconductor chip 10 on which the electrodes 12 are formed faces the side of the substrate 20 on which the leads 22 are formed. The electrodes 12 (bumps 16) are bonded to the leads 22. The electrodes 12 (bumps 16) may be bonded to the leads 22 by using a junction method such as a metal junction method or a bonding junction method. As shown in FIG. 3, the junction surface of the electrode 12 (bump 16) bonded to the lead 22 and the junction surface of the lead 22 bonded to the electrode 12 (bump 16) may have different sizes (the former may be larger than the latter, for example). The surface layer 24 (Sn) of the lead 22 having a junction surface smaller than that of the electrode 12 (bump 16) may have a melting point lower than that of the inner layer 26 (Cu). At least the surface layer of the electrode 12 (at least the surface layer of the bump 16 (Au)) and at least the surface layer 24 (Sn) of the lead 22 may be formed of different materials.

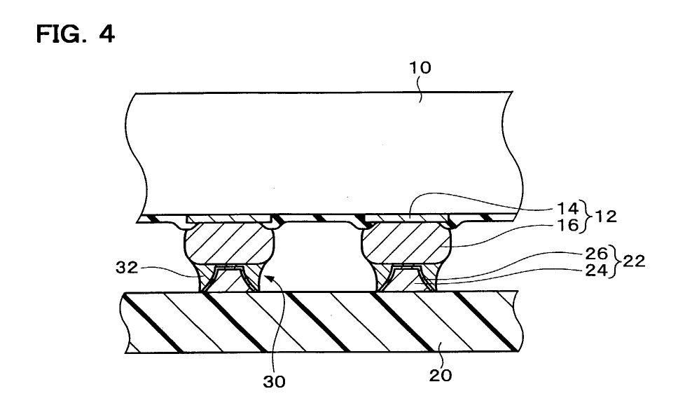

As shown in FIG. 4, a bonded section 30 between the electrode 12 (bump 16) and the lead 22 may include a eutectic alloy 32 (eutectic Au—Sn, for example).

A method of manufacturing a semiconductor device according to this embodiment is described below. The method of manufacturing a semiconductor device includes mounting the semiconductor chip 10 on the substrate 20 by a face down bonding step. For example, a surface of the semiconductor chip 10 on which the electrodes 12 are formed is disposed to face a surface of the substrate 20 on which the leads 22 are formed, and then the electrodes 12 are bonded to the leads 22, as shown in FIG. 2. In this case, an adhesive may be previously provided on the surface of the semiconductor chip 10 on which the electrodes 12 are formed or the surface of the substrate 20 on which the leads 22 are formed before mounting the semiconductor chip 10 on the substrate 20. FIG. 3 is a partially enlarged view of FIG. 2.

A manufacturing apparatus for a semiconductor device according to this embodiment includes a bonding tool 40 for bonding the semiconductor chip 10 to the substrate 20, and a bonding stage 42 on which the substrate 20 is placed. At least a section of the bonding stage 42 which is in contact with the substrate 20 is formed of a material having a thermal conductivity of 15 to 30 W·m⁻¹·K⁻¹, such as stainless steel. The material having a thermal conductivity of 15 to 30 W·m⁻¹·K⁻¹ (stainless steel, for example) may be used only for a surface of the bonding stage 42, or only for a section of the bonding stage 42 which is in contact with the substrate 20. In this case, the section formed of the material having a thermal conductivity of 15 to 30 W·m⁻¹·K⁻¹ (stainless steel, for example) may be formed to be removable. This enables to replace only that section if the substrate 20 adheres to the section due to heat. Alternatively, the entire bonding stage 42 may be formed of the material having a thermal conductivity of 15 to 30 W·m⁻¹·K⁻¹ (stainless steel, for example). In this way, since at least a section of the bonding stage 42 which is in contact with the substrate 20 is formed of a material having a thermal conductivity of 15 W·m⁻¹·K⁻¹ or more, heat in the substrate 20 can be released from the bonding stage 42. Therefore, the heat influence on the substrate 20 can be reduced. Moreover, since at least a section of the bonding stage 42 which is in contact with the substrate 20 is formed of a material having a thermal conductivity of 30 W·m⁻¹·K⁻¹ or less, sufficient heat can be applied in the bonding step of the semiconductor chip 10 and the substrate 20 to bond the electrodes 12 to the leads 22, or to cure an insulating thermosetting adhesive provided between the semiconductor chip 10 and the substrate 20.

The substrate 20 is mounted on the bonding stage 42. The semiconductor chip 10 is mounted on the substrate 20. Pressure is applied to the semiconductor chip 10 by the bonding tool 40. In other words, the semiconductor chip 10 and the substrate 20 are sandwiched between the bonding tool 40 and the bonding stage 42. The semiconductor chip 10 and the substrate 20 are disposed so that the electrodes 12 face the leads 22. Pressure is applied to the electrodes 12 and the leads 22.

Heat is applied to the electrodes 12 and the leads 22 from the bonding tool 40. Either pressure or heat may be applied first. Pressure and heat may be applied simultaneously. For example, pressure may be applied to the electrodes 12 and the leads 22 by the bonding tool 40 which is heated in advance. The electrodes 12 and the leads 22 are then bonded to each other. As shown in FIG. 4, the eutectic alloy 32 may be formed in the bonded section. The bonding tool 40 is then lifted.

As shown in FIG. 1, a space between the semiconductor chip 10 and the substrate 20 may be filled with an underfill material 36.

According to this embodiment, the heat influence on the substrate 20 from the bonding tool 40 or the bonding stage 42 is small. Since the heat expands the substrate 20 to only a small extent, the pitch of the leads 22 is not significantly increased. Therefore, the leads 22 and the electrodes 12 are easily positioned. Moreover, the electrodes 12 (bumps 16) bonded to the leads 22 are not tilted to a large extent. Since the heat does not deform the substrate 20 to a large extent, the leads 22 do not come in contact with the semiconductor chip 10. Since the heat softens the substrate 20 to only a small extent, the electrodes 12 do not sink into the substrate 20. Therefore, the gap between the substrate 20 and the semiconductor chip 10 can be secured sufficiently, whereby the gap can be filled with the underfill material 36 and occurrence of voids can be eliminated. The eutectic alloy 32 formed in the bonded section 30 of the leads 22 and the electrodes 12 will not be significantly deformed in the direction of the pitch of the electrodes 12 (or bumps 16) , so that occurrence of short circuits between the adjacent electrodes 12 can be prevented.

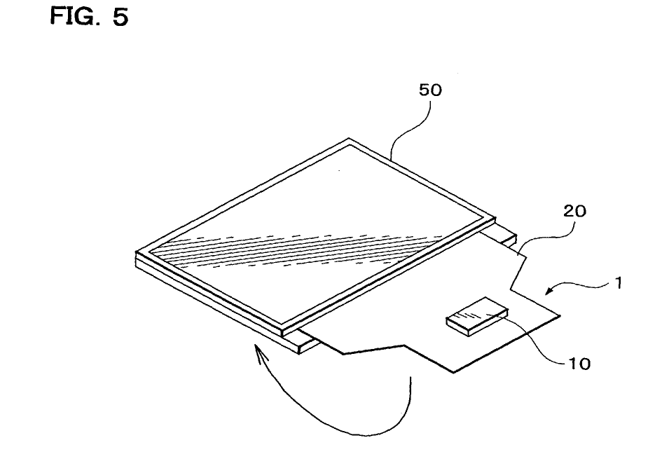

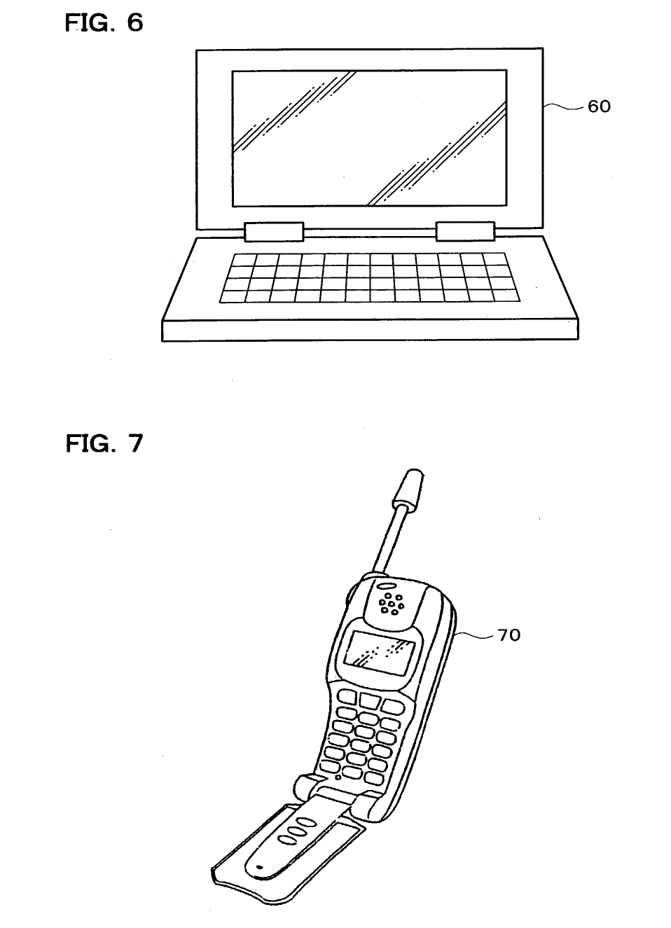

FIG. 5 is a view showing an example of a semiconductor device according to this embodiment of the present invention. In this example, a semiconductor device 1 in the form of COF (Chip On Film) is attached to a liquid crystal panel 50. The semiconductor device 1 includes the above-described semiconductor chip 10 and substrate 20. The liquid crystal panel 50 may be referred to as an electronic instrument. FIGS. 6 and 7 respectively show a notebook personal computer 60 and a portable telephone 70 as examples of electronic instruments including the semiconductor device according to one embodiment of the present invention.

The present invention is not limited to the above-described embodiments, and various modifications can be made. For example, the present invention includes various other configurations substantially the same as the configurations described in the embodiments (in function, method and effect, or in objective and effect, for example). The present invention also includes a configuration in which an unsubstantial portion in the described embodiments is replaced. The present invention also includes a configuration having the same effects as the configurations described in the embodiments, or a configuration able to achieve the same objective. Further, the present invention includes a configuration in which a publicly known technique is added to the configurations in the embodiments.

What is claimed is:

1. A method of manufacturing a semiconductor device comprising:
placing a substrate on a bonding stage; and
bonding a semiconductor chip to the substrate,
wherein at least a section of the bonding stage which is in contact with the substrate is formed of a material having a thermal conductivity of 15 to 30 W·m⁻¹·K⁻¹.

2. The method of manufacturing a semiconductor device as defined in claim 1,
wherein the material of the bonding stage is stainless steel.

3. A semiconductor device manufactured by the method as defined in claim 1.

4. A semiconductor device manufactured by the method as defined in claim 2.

5. An electronic instrument comprising the semiconductor device as defined in claim 3.

6. An electronic instrument comprising the semiconductor device as defined in claim 4.

7. A manufacturing apparatus for a semiconductor device comprising:
a bonding stage on which a substrate is placed; and
a bonding tool for bonding a semiconductor chip to the substrate,
wherein at least a section of the bonding stage which is in contact with the substrate is formed of a material having a thermal conductivity of 15 to 30 W·m⁻¹·K⁻¹.

8. The manufacturing apparatus for a semiconductor device as defined in claim 7,
wherein the material for the bonding stage is stainless steel.
